(19) United States
(12) Patent Application Publication
(10) Pub. No.: US 2020/0302516 A1
(43) Pub. Date: Sep. 24, 2020

(54) REAL-TIME OBJECT IDENTIFICATION AND TRACKING NETWORK

(71) Applicant: BANK OF AMERICA CORPORATION, Charlotte, NC (US)

(72) Inventors: Therese H. Willis, Apopka, FL (US); Lee Ann Proud, Ponte Vedra, FL (US); Martha Sain McClellan, Lancaster, SC (US)

(21) Appl. No.: 16/359,044

(22) Filed: Mar. 20, 2019

(51) Int. Cl. G06Q 40/02; H04L 29/06; G06Q 20/02; G06Q 20/38

(52) U.S. Cl. CPC G06Q 40/02; H04L 63/10; G06Q 20/3829; G06Q 20/3827; G06Q 20/02

(57) ABSTRACT

Embodiments of the invention are directed to provisioning object identification and volume data in conjunction with the real-time processing of a resource event. The object identification and volume data is included in or accessible via one or more resource event messages communicated to the object recipient. In addition, the object identification and volume data is linked or otherwise provided in real-time to an object tracking management system associated with the object receipt, so that the system can immediately update the object registers associated with each of the objects.

### FIELD OF THE INVENTION

The present invention is generally directed to real-time resource event processing and, more specifically, a system that provides for real-time object identification and tracking management in conjunction with real-time resource event processing.

### BACKGROUND

A need exists to develop systems, apparatus, methods or the like for providing real-time object identification in conjunction with real-time resource event processing. In addition a new exists to able to provide the object identification data to object tracking management system in real-time so that the object registers within the system are immediately updated to reflect current object state. Moreover, a need exists to provide, in real-time, to a similar object tracking management system associated with the object provider, data associated with the updated object registers of the object recipient so that the object provider is immediately aware of the current object state of the object recipient.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, apparatus, methods and/or the like for provisioning object identification and volume data in conjunction with the real-time processing of a resource event. The object identification and volume data is included in or accessible via one or more resource event messages communicated to the object recipient. In addition, the object identification and volume data is linked or otherwise provided in real-time to the object tracking management system associated with the object receipt, so that the system can immediately update the object registers associated with each of the objects.

In specific embodiments of the invention, the object identification and volume data is included in a resource event request message initiated by the object provider. In other embodiments of the invention, the object identification and volume data is made accessible to the object recipient by including an activatable pointer/link within the resource event request message that, when activated, provides network access to an object depository that stores the object identification and volume data. In still further specific embodiments of the invention, another resource event message, sent after the resource event request message, such as a remittance message, may include the object identification and volume data and/or an activatable pointer/link within the resource event request message.

A system for providing real-time object identification and tracking management defines first embodiments of the invention. The system includes a real-time processing computer network configured to process a resource event between an object provider and an object recipient in real-time. The real-time processing computer network includes a first computing platform having a first memory and at least one first processor in communication with the first memory. The first memory stores first instructions that are executable by the at least one first processor and configured to provide one or more resource event messages to the object recipient that includes or provides access to object identification and volume data related to one or more objects being provided to the object recipient as a result of the resource event. The system additionally includes a first object tracking management system associated with the object recipient and configured to manage acquisition and storage of objects. The first object tracking management system includes a second computing platform having a second memory and at least one second processor in communication with the second memory. The second memory stores second instructions that are executable by the at least one second processor and configured to receive, in real-time with the processing of the resource event or proximate in time to the resource event, the object identification and volume data related to the one or more objects, and update an object register associated with each of the one or more objects to include the object identification and volume data related to each of the one or more objects.

In specific embodiments of the system, the first instructions configured to provide the one or more resource event messages are further configured to provide (i) a resource event request message to the object recipient that includes the object identification and volume data related to the one or more objects being provided to the object recipient and/or, in other embodiments of the system, (ii) a resource event request message to the object recipient that includes an activatable pointer to a data repository that stores the object identification and volume data related to the one or more objects being provided to the object recipient. In other specific embodiments of the system, the first instructions configured to provide the one or more resource event messages are further configured to logically determine to include in a resource event request message at least one selected from the group of (i) the object identification and volume data related to the one objects, and (ii) an activatable pointer to a data repository that stores the object identification and volume data related to the one or more objects being provided to the object recipient. In still further specific embodiments of the system, the first instructions configured to provide the one or more resource event messages are further configured to, in response to providing a resource event request to the object recipient and receiving an object data request from the object recipient, provide a remittance message to the object recipient that includes the object identification and volume data related to the one or more objects being provided to the object recipient and/or an activatable pointer to a data repository that stores the object identification and volume data.

In still further specific embodiments of the invention, the second instructions are further configured to communicate data associated with the updated object registers associated with each of the one or more objects. In such embodiments the system may further includes a second object tracking management system associated with the object provider and configured to manage allotment and storage of objects. The second object tracking and management system includes a third computing platform having a third memory and at least one third processor in communication with the third memory. The third memory stores third instructions that are executable by the at least one third processor and configured to receive the data associated with the updated registers associated with each of the objects and update, in real-time with the processing of the resource event, an object recipient-specific object register associated with each of the one or more objects to include the data associated with the updated object registers.

In still further specific embodiment the system further includes a resource event reconciliation management system associated with the object recipient. The resource event reconciliation management system includes a third computing platform having a third memory and at least one third processor in communication with the third memory. The third memory stores third instructions that are executable by the at least one third processor and configured to receive, in real-time with the processing of the resource event, the object identification and volume data related to the one or more objects, and reconcile a prior instruction made by the object recipient for receiving the one or more objects. In specific embodiments of the system, the third instructions configured to reconcile the prior instructions are further configured to reconcile the prior instructions by confirming that (i) an identity of the one or more objects and (ii) a volume of each of the one or more objects in the resource event matches the prior instructions.

In specific embodiments of the system, the first instructions are further configured to format the object identification and volume data so as to be readable by the first object tracking management system.

An apparatus for providing object identification and volume data as part of a real-time resource event defines second embodiments of the invention. The apparatus includes a computing platform having a memory and at least one processor in communication with the memory. The memory stores instructions that are executable by the at least one processor and configured to process, in real-time, a resource event between an object provider and an object recipient and, while processing the resource event, provide one or more resource event messages to the object recipient that includes or provides access to object identification and volume data related to one or more objects being provided to the object recipient.

In further embodiments of the apparatus, the instructions configured to provide the one or more resource event messages are further configured to provide a resource event request message to the object recipient that includes (i) the data related to the one or more objects being provided to the object recipient and/or (ii) an activatable pointer to a data repository that stores the data related to the one or more objects being provided to the object recipient. In specific embodiments of the apparatus, the instructions configured to provide the one or more resource event messages are further configured to logically determine to include, in a resource event request message, at least one selected from the group of (i) the data related to the one objects, and (ii) a an activatable pointer to a data repository that stores the data related to the one or more objects being provided to the object recipient. In other related embodiments of the invention, the instructions configured to provide the one or more messages are further configured to, in response to providing a resource event request to the object recipient and receiving an object data request from the object recipient, provide a remittance message to the object recipient that includes the data related to the one or more objects being provided to the object recipient.

A computer program product including a non-transitory computer-readable medium. The computer-readable medium includes a first set of codes for causing a computer to process, in real-time, a resource event between an object provider and an object recipient. In addition, the computer-readable medium includes a second set of codes for causing a computer, while processing the resource event, provide one or more resource event messages to the object recipient that includes or provides access to object identification and volume data related to one or more objects being provided to the object recipient.

In specific embodiments of the computer program product, the second set of codes is further configured to provide a resource event request message to the object recipient that includes at least one (i) the data related to the one or more objects being provided to the object recipient and/or (ii) an activatable pointer to a data repository that stores the data related to the one or more objects being provided to the object recipient.

In still further specific embodiments of the computer program product, the second set of codes is further configured to, in response to providing a resource event request to the object recipient and receiving an object data request from the object recipient, provide a remittance message to the object recipient that includes the data related to the one or more objects being provided to the object recipient.

In other embodiments the computer-computer readable medium of the computer program product further includes a third set of codes for causing a computer to format the object identification and volume data so as to be readable by the first object tracking management system.

Thus, according to embodiments of the invention, which will be discussed in greater data below, the present invention provides for object identification and volume data in conjunction with a real-time processing resource event. The object identification and volume data is included in or accessible via one or more resource event messages communicated to the object recipient. In addition, the object identification and volume data is linked or otherwise provided in real-time to the an object tracking management system associated with the object receipt, so that the system can immediately update the object registers associated with each of the objects.

The features, functions, and advantages that have been discussed may be achieved independently in various embodiments of the present invention or may be combined with yet other embodiments, further data of which can be seen with reference to the following description and drawings.

### INCORPORATION BY REFERENCE

To supplement the present disclosure, this application further incorporates entirely by reference the following commonly assigned patent applications:

| | U.S. Patent | | |
|---|---|---|---|
| | Application | | |
| Docket Number | Ser. No. | Title | Filed On |
| 8868US1.014033.3396 | To Be | REAL-TIME | Concurrently |
| | Assigned | RESOURCE | Herewith |
| | | SPLIT | |
| | | DISTRIBUTION | |
| | | NETWORK | |

### BRIEF DESCRIPTION OF THE DRAWINGS

Having thus described embodiments of the disclosure in general terms, reference will now be made to the accompanying drawings, wherein:

FIG. 1 is a schematic diagram of a system for providing object identification and volume data in conjunction with in a real-time processing computing network, in accordance with some embodiments of the present disclosure;

FIG. 2 is a schematic diagram of a system for providing object identification and volume data in conjunction with in a real-time processing computing network using a clearing house system, in accordance with embodiments of the present invention;

FIG. 3 is a schematic diagram of a system for providing item/service identification and volume data in conjunction with in a real-time payment network, in accordance with embodiments of the present invention;

FIG. 4 is a schematic diagram of a system for providing item/service identification and volume data in conjunction with in a real-time payment network using a clearing house system, in accordance with embodiments of the present invention;

FIG. 5 is a block diagram of an apparatus for providing object identification and volume data in conjunction with in a real-time processing computing network, in accordance with some embodiments of the present disclosure; and

FIG. 6 is a flow diagram of a method providing object identification and volume data in conjunction with in a real-time processing computing network, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, systems, apparatus, and methods are described in data below for provisioning object identification and volume data in conjunction with the real-time processing of a resource event. The object identification and volume data is included in or accessible via one or more resource event messages communicated to the object recipient. In addition, the object identification and volume data is linked or otherwise provided in real-time to the object tracking management system associated with the object receipt, so that the system can immediately update the object registers associated with each of the objects.

In specific embodiments of the invention, the object identification and volume data is included in a resource event request message initiated by the object provider. In other embodiments of the invention, the object identification and volume data is made accessible to the object recipient by including an activatable pointer/link within the resource event request message that, when activated, provides network access to an object depository that stores the object identification and volume data. In still further specific embodiments of the invention, another resource event message, sent after the resource event request message, such as a remittance message, may include the object identification and volume data and/or an activatable pointer/link within the resource event request message.

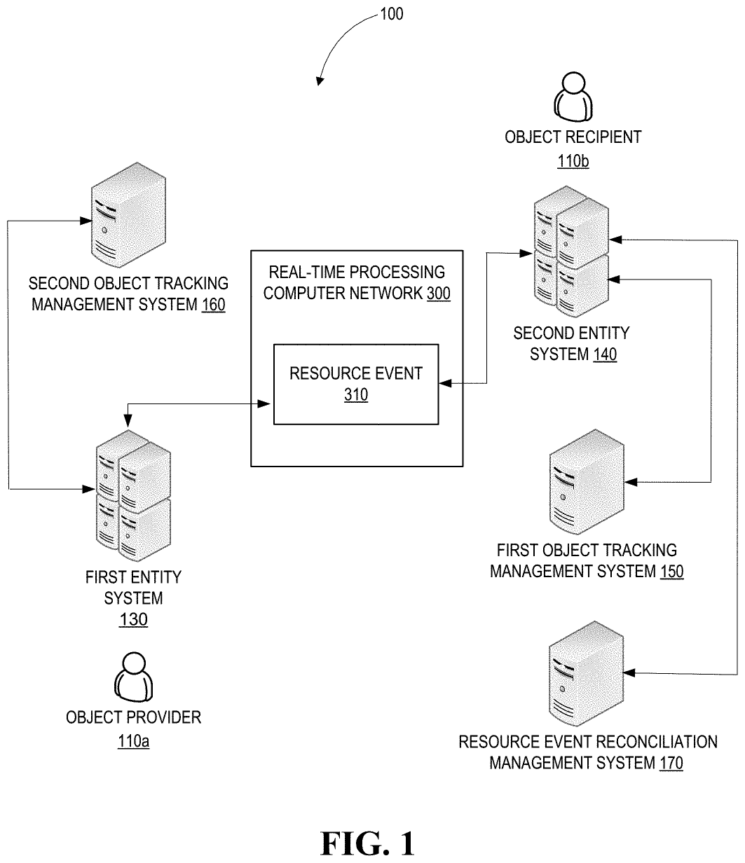

FIG. 1 illustrates a block diagram of a high-level real-time processing system 100, in accordance with embodiments of the present invention. In the illustrated system 100, an object provider 110A is associated with a first entity system 130 and an object recipient 110B is associated with a second entity system 140. A real-time processing network 300 is configured to process, in real-time, a resource event 310, in which object provider 100a provides one or more objects and object recipient 100b receives the one or more objects. In specific embodiments of the invention, real-time processing provides for the resources to be available to the object provider 110A immediately (i.e., once the real-time processing network 300 has completed processing the resource event 310). In other embodiments of the invention, real-time processing provides for the resource event 310 to be cleared/settled upon completion of processing by the real-time processing network 300. In specific embodiments of the invention, the real-time processing nature means that once the object recipient 100a accepts the resource event request, the resource event 310 event is deemed irrevocable (i.e., the resource event cannot be cancelled or otherwise prevented from completion).

In specific embodiments of the invention, the object provider 110A and the object recipient 110B are authorized users of the real-time processing system 100, such that, the object provider 110A initiates a resource event request, in which the object recipient 110B is the resource provider. In specific embodiments of the invention, the object recipient 110B accepts/initiates the resource event from the second entity system 140 by providing requisite authentication information, which serves to authenticate the identity of the object recipient 110B. In specific embodiments of the invention, authentication of an identity may include multi-factor/multi-step authentication (i.e., involving one or more computing devices) as required by information security standards and requirements. The object recipient 100B may also provide, as part of the authentication information, a resource depository identifier, which serves to identify a source for resources associated with the resource event 310. In such embodiments of the invention, second entity system 140 may authenticate the validity of the resource depository and validate that the resource depository currently stores a sufficient volume of resources to process the resource event 310.

In specific embodiments of the invention, once the object provider 100A initiates the resource event 310, the object recipient 110B, as the resource recipient, receives a resource event request message/communication, via the second entity system 140 to accept the resources (i.e., accept the resource event) following performance of requisite user authentication requirements. In specific embodiments of the invention, the resource event request message/communication includes or provides network access to object identification and volume data that indicates the object(s) and the volume of objects being provided to the object recipient 100b as a result of the resource event 310. The object identification and volume may be imported from repository associated with the object provider or manually inputted by the individual requesting resource event. In other embodiments of the invention, other communication between the object provider 100A and object recipient 100B may include object identification and volume data (e.g., a remittance message/communication or the like). The resource event request message and other communication between object provider 100A and object recipient 100B related to the resource event is transmitted between the first and second entity systems 130 and 140 via the real-time processing network 300.

The real-time processing network 300 is configured to direct the resources to the appropriate entity system associated with resource recipient, in this instance second entity system 140 associated with the object recipient 100b.

In addition, the system 100 includes first object-tracking management system 150 that is associated with the object recipient 100B and is configured to manage acquisition and storage of the objects. Specifically, the first object-tracking management system 150 is configured to receive, in real-time with the processing of the resource event or proximate in time to processing the resource event, the object identification and volume data related to the object(s) associated with the resource event 310. In specific embodiments of the system, the object identification and volume data is received from the second entity system 140, while in other embodiments of the system, the identification and volume data may be received directly from the real-time processing computer network 300. In response to receiving the data, the object-tracking management system 150 is configured to update the object register associated with each of the object(s) based on the object identification and volume data. In specific embodiments of the invention, the updated object registers may trigger object acquisition system to provide an object order to the object provider 100A, which, in turn, may trigger a subsequent resource event 310.

In optional embodiments the system 100 may further include second object tracking management system 160 that is associated with the object provider 100A and is configured to manage allotment and storage of objects. Specifically, in optional embodiments of the system, the second object-tracking management system 160 is configured to receive data associated with the updated object registers of the first object-tracking management system 150 and, in response, update, in real-time with the processing of the resource event, object recipient-specific register(s) associated with the one or more objects being transferred in the resource event 310. In specific embodiments of the invention, the second object tracking management system 160 receives the data associated with the updated object registers from the first entity system 130, which has received the data from the second entity system 140 (via networks other than the real-time processing network 300).

In other optional embodiments the system 100 includes an object reconciliation management system 170 that is associated with either the object provider 110A and/or the object recipient 110B and is configured to receive, in real-time with the processing of the resource event, the object identification and volume data and reconcile a prior instruction (e.g., an order) made by the object recipient for receiving the one or more objects.

It should be understood that while the illustrated embodiment of FIG. 1 depicts only first and object recipients 100A and 100B, and first and second entity systems 130 and 140, in actual embodiments of a real-time processing network 300 numerous entity systems having corresponding numerous users (i.e., object providers and recipients) may interact with the real-time processing network 300 to process, as needed, resource events 310 in real-time.

In accordance with specific embodiments of the invention, the terms “entity system” may include any computing system comprising one or more computing devices (e.g., servers, storage devices, personal computers (PCs) and the like) associated with entity/organization having a need to process resource events in real-time.

Furthermore, the terms “object provider” and “object recipient” may include a single individual or a group of individuals that desire to perform a resource event in real-time. The “object provider” and “object recipient”, as referenced herein, may refer to an individual or group of individuals that has the ability and/or authorization to access and use one or more resources or portions of a resource and request and initiate real-time processing via the real-time processing network 300. Moreover, the association between the object provider(s)/recipient(s) and the entity systems may be a one-time association for the purpose of processing the resource event in real-time or the association may be an ongoing association in which the users regularly process resource events, those in real-time and otherwise, with the associated entity system.

As used herein, the term “computing device” or “mobile device” or “communication device” may refer to mobile phones, personal computing devices, tablet computers, wearable devices, smart devices and/or any portable electronic device capable of receiving (wirelessly or otherwise) and/or storing data therein.

A “system”, as used herein, may refer to any information technology (IT) platform and may include a plurality of computing devices, such as servers, mainframes, personal computers, network devices (portable and otherwise), front and back end devices, database/storage devices and/or the like.

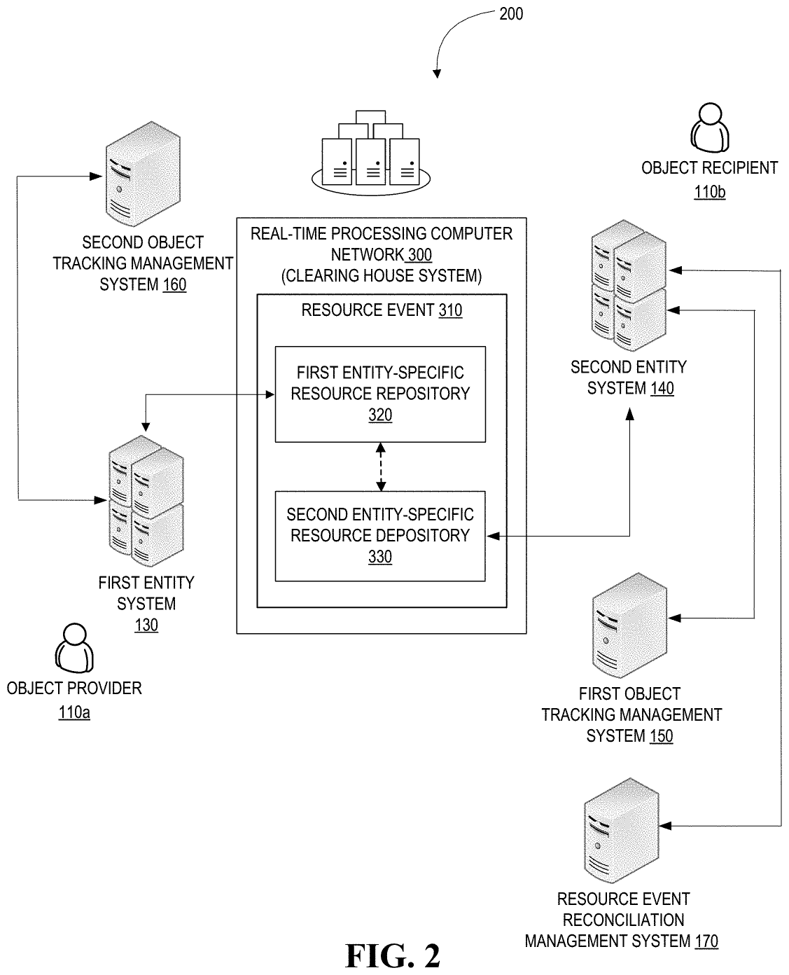

Referring to FIG. 2 a block diagram is depicted of a high-level real-time processing system 200, in accordance with one embodiment of the invention. In the illustrated embodiments, an object provider 110A is associated with a first entity system 130 and an object recipient 110B is associated with a second entity system 140. The real-time processing network 300 is configured as a clearing house system in which the resource event 310 is conducted between a first entity-specific resource depository 320 and a second entity-specific resource depository 330. The first entity-specific resource depository 320 and the second entity-specific resource depository 330 are accessible by each respective entity system, i.e., first entity-specific resource depository 320 is accessible to first entity system 130 and second-entity-specific resource depository 330 is accessible to second entity system 140. The real-time processing network 300 acts as a trusted intermediary during completion (e.g., clearing/settlement) of the resource event 310. Resources are transferred by each entity system 130 and 140 to and from their respective entity-specific resource depositories 320 and 330. Resource transfers between the object provider-specific resource depository 132 and the object recipient-specific resource depository 142 are administered by the real-time processing computer network/clearing house system 300 pending authentication and authorization of the object provider(s) and object recipient(s) 110A and 100B and/or user-specific resource depositories as required by the resource event 310.

The clearing house system of the real-time processing computer network 300 is configured to direct the resources to the appropriate entity system associated with the object provider 100B. The transfer of resources occurs between the first entity-specific resource depository 320 and second entity-specific resource depository 330 on behalf of their associated object provider(s)/recipient(s) 110A and 110B, wherein the resource event 310 may be cleared/settled at the entity systems immediately, concurrent with the completion of the resource event 310. As settlement occurs between the representative entity systems 130 and 140, resources are deleted from and added to corresponding user-specific resource depositories. As a result of the resource event being settled immediately, the resources are made available for use by the object provider 100A in real or near real-time.

In specific embodiments of the invention, the system 200 may further comprise more than one real-time processing computer networks 300/clearing house systems that receive and process resource event requests as described herein.

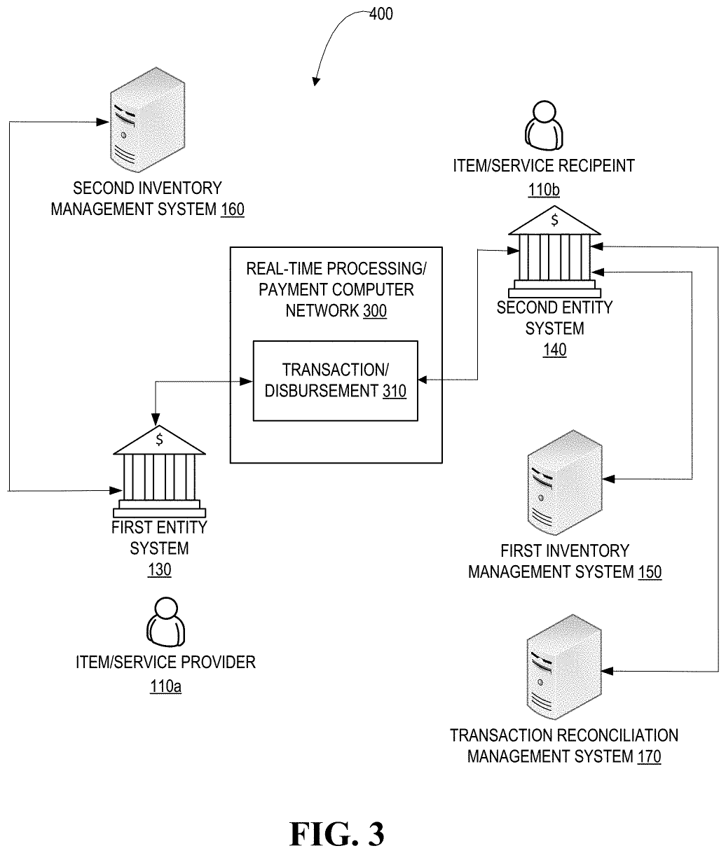

Referring to FIG. 3 a block diagram is shown of a high-level real-time processing system 400, in accordance with embodiments of the present invention. In the illustrated system 100, an object provider 110A is associated with a first entity system 130, such as a customer of a first financial institution and an object recipient 110B is associated with a second entity system 140, such as a customer of a second financial institution. In this regard the real-time processing network 300 otherwise referred to as a real-time payment (RTP) network is configured to process, in real-time, a resource event in the form of a transaction/disbursement 310 of funds, in which item/service provider 100A receives the funds and item/service recipient 100B provides the funds. In specific embodiments of the invention, real-time payment provides for the funds to be available to the recipient (i.e., item/service recipient/customer 100B) immediately (i.e., once the real-time payment network 300 has completed processing the transaction/disbursement 310). In other embodiments of the invention, real-time payment provides for the transaction/disbursement 310 to be cleared/settled upon completion of processing by the RTP network 300. In specific embodiments of the invention, the real-time aspect of RTP network 300 means that once the object provider 100A initiates the transaction/disbursement 310, the transaction/disbursement 310 is deemed irrevocable (i.e., the transaction/disbursement cannot be cancelled, interrupted or otherwise prevented from completion/settlement) and the item/service recipient 100B bares an obligation to remit the funds to the item/service provider 100A.

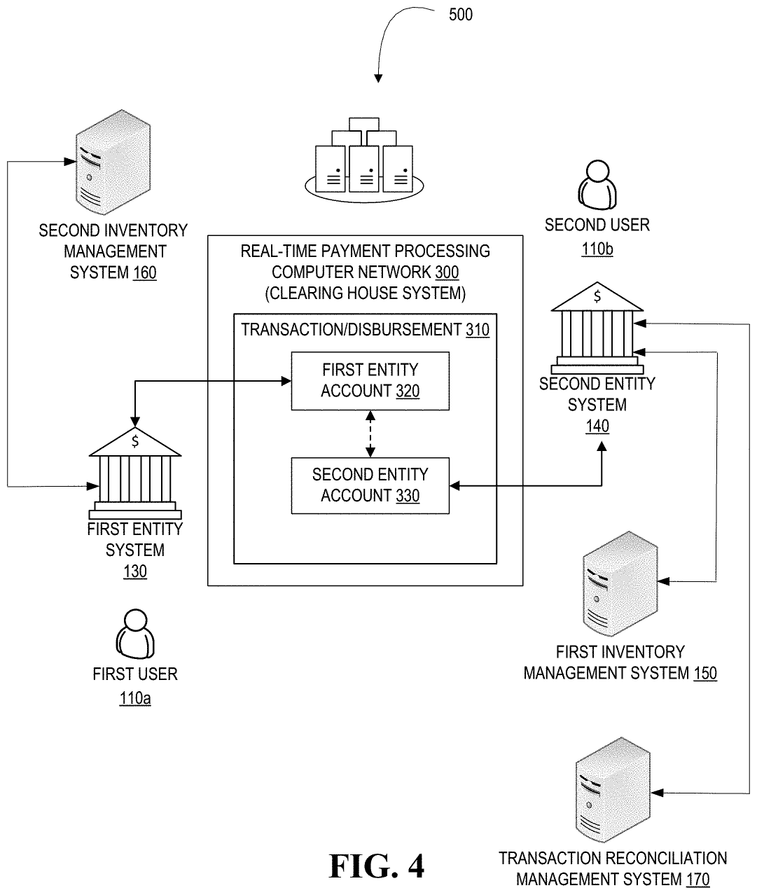

In specific embodiments of the invention, the RTP network 300 is configured to communicate in accordance with an industry-wide standard messaging protocol. For example, in specific embodiments of the invention, the messaging protocol may adhere to International Organization for Standardization (ISO) standard 20022, which detects the format and rules for communicating messages/commands between the entity systems 130 and 140 and the RTP network 300. In specific embodiments of the invention, the transaction/disbursement 310 may occur, in its entirety, via a series of messages communicated between the entities 130 and 140 via the RTP network 300. While in other embodiments of the invention, such as those, discussed in relation to FIG. 4, infra., the RTP network 300 may implement a clearing house system.

In specific embodiment of the invention, the item/service provider 110A and the item/service recipient 110B are predetermined users (i.e., registered users) of the real-time processing system 400, wherein the item/service provider 110A (i.e., the payee) initiates a request for payment to the item/service recipient 110B (i.e., the payor).

In specific embodiments of the invention, the item/service recipient 110B may initiate the transfer from the second entity system 140 in response to the item/service recipient 110B providing authentication information to authenticate the identity of the item/service recipient 110B and validity of item/service recipient 110B account held at the second entity system 140. The authentication information may include account numbers, routing numbers, PIN numbers, username and password, date of birth, social security number, or the like, or other authentication information as described herein. As previously described, in some embodiments of the invention, user identity authentication may comprise multi-factor/multi-step authentication as prescribed by information security standards and requirements. In addition, the system 400 may provide for authorizing the transaction/disbursement 310 based on verifying the item/service recipient account 132 held at the second entity system 140 currently stores at least a sufficient amount of available funds to fulfill the transfer/disbursement 310. While in certain embodiments of the invention, the item/service provider 110A initiates the transfer from a physical, brick-and-mortar location of the first entity system 130, in alternative embodiments described herein, the transfer may be initiated from other locations in which the item/service provider 110A and/or item/service recipient 110B are not required to be at a brick-and-mortar location (e.g., via an electronic application, a website, a point-of-sale (POS) device or the like).

Upon the item/service provider 110A initiating transaction/disbursement 310, the item/service recipient 110B, as the payor, receives a payment request message to accept payment in response to the item/service provider 110A providing requisite authentication information and the system 400 verifying the identity of the object recipient and the validity of the object recipient account. As previously discussed, the real-time payment request message may include or provide network-access to invoice data that lists the item(s)/service(s) associated with the transaction and the associated amounts of each item/service. In alternate, embodiments of the invention, the invoice data may be communicated to the item/service recipient 100B in a subsequent message, such as a remittance message or the like. The invoice data may be imported from repository associated with the item/service provider 100A or manually inputted by the individual requesting transaction/disbursement 310. As previously discussed, communication related to the transaction/disbursement 310 between first and object recipient 100A is transmitted between the first and second entity systems 130 and 140 via the real-time processing network 300 which directs the payment to the appropriate entity (e.g., first entity system 130) associated with the item/service provider 100A). As settlement occurs between the representative first and second entity systems 130 and 140, debiting and crediting of individual user accounts (i.e., item/service provider and recipient accounts) may be managed at each entity system. As the transaction/disbursement is settled immediately, funds may be made available for use by the item/service provider 100A) in real or near real-time.

In addition, the system 400 includes first inventory management system 150 that is associated with the item/service recipient 110B and is configured to manage acquisition and storage of the items/service. Specifically, the first inventory management system 150 is configured to receive, in real-time with the processing of the transaction/disbursement 310, the invoice data related to the items/services associated with the transaction/disbursement 310. In specific embodiments of the system, the invoice data is received from the second entity system 140, while in other embodiments of the system, the invoice data may be received directly from the real-time payment network 300. In response to receiving the data, the inventory management system 150 is configured to update the item/service listings associated with each of the item(s)/service(s) based on the invoice data. In this regard, the inventory management system 150 is able to immediately account for the items/services associated with the real-time payment transaction/disbursement 310. In specific embodiments of the invention, the updated item/service listings may trigger, in the event current inventory for an item/service does not meet current demand or the like, an object acquisition system (i.e., ordering system) (not shown in FIG. 3) to place an item/service order with the item/service provider 100A, which, in turn, may trigger a subsequent real-time transaction/disbursement 310.

In optional embodiments the system 400 may further include second inventory management system 160 that is associated with the item/service provider 100A and is configured to manage allotment and storage of objects. Specifically, in optional embodiments of the system, the second inventory management system 160 is configured to receive data associated with the updated item/service listings of the first inventory management system 150 and, in response, update, in real-time with the processing of the resource event, item/service recipient-specific listings associated with the one or more item/service being transferred in the real-time transaction/disbursement 310. In this regard, the item/service provider's inventory management system 160 may immediately reflect the item/service recipient's current inventory for an item/service in the real-time payment transaction. In specific embodiments of the invention, the second inventory management system 160 receives the data associated with the updated item/service listings from the first entity system 130, which has received the data from the second entity system 140 (via the real-time processing network 300 or networks other than the real-time processing network 300 (e.g., Internet or the like)).

In other optional embodiments the system 400 includes an object reconciliation management system 170 that is associated with either the item/service recipient 110B and is configured to receive, in real-time with the processing of the transaction/disbursement 310, the invoice data and reconcile a prior order for the items/services in the order, i.e., insure that the items/services in the order are correct and that the quantity of the items are consistent with the quantity in the order.

The first and second entity systems 130 and 140 may be associated with financial institutions or any other entity/organization that processes financial transactions/disbursements or the like. Additionally, it should be appreciated by someone with ordinary skill in the art that the item/service recipient and/or provider may be an existing customer of the financial institution or a potential customer of the financial institution or the like.

Referring to FIG. 4 a block diagram is depicted of a high-level real-time processing system 500, in accordance with one embodiment of the invention. In the illustrated embodiments, an item/service provider 110A is associated with a first entity system 130, such as a customer of a first financial institution and an item/service recipient 110B is associated with a second entity system 140, such as a customer of a second financial institution. The real-time processing network 300 is a real-time payment (RTP) network configured as a clearing house system in which the transaction/disbursement 310 is conducted between a first entity-specific account 320 and a second entity-specific account 330. The first entity-specific account 320 and the second entity-specific account 330 are accessible by each respective entity system, i.e., first entity-specific account 320 is accessible to first entity/financial institution system 130 and second entity-specific account 330 is accessible to second entity/financial institution system 140. The RTP network 300 acts as a trusted intermediary during settlement of the transaction/disbursement 310. Funds are transferred by each entity system 130 and 140 to and from their respective entity-specific accounts 320 and 330. Fund transfers between the first entity-specific account 320 and the second entity-specific account 330 are administered by the clearing house system 300 pending authentication and authorization of the object provider and recipient 110A and 100B and/or the user accounts as required by the transaction/disbursement 310.

The clearing house system of the RTP network 300 is configured to direct the funds to the appropriate entity system/financial institution associated with the item/service provider 100A (i.e., payee). The transfer of funds occurs between the first entity account 320 and second entity account 330 on behalf of their associated item/service provider 110A and item/service recipient 110B. As such, the transaction/disbursement 310 may be cleared/settled at the entity systems/financial institutions immediately, concurrent with the completion of the transaction/disbursement. As settlement occurs between the representative entity systems/financial institutions 130 and 140, funds are debited and credited to the corresponding item/service recipient and provider 110B and 110A accounts (not shown in FIG. 4). As a result of the transaction/disbursement being settled immediately, the funds are made available for use by the payee (e.g., object provider 100A) in real or near real-time.

In specific embodiments of the invention, the system 300 may further comprise more than one RTP network 300/clearing house system that receive and process transaction/disbursement requests as described herein.

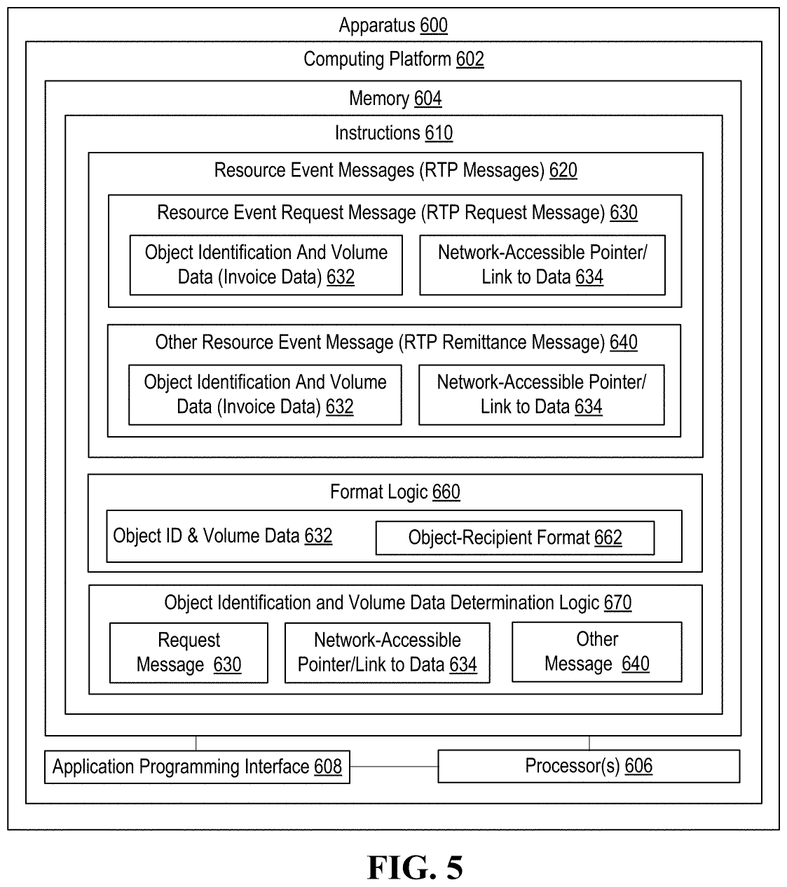

Referring to FIG. 5 a block diagram is presented of apparatus 600 configured for providing object identification and volume data in conjunction with a real-time resource event, in accordance with embodiments of the invention. Apparatus 600 may comprise one or more computing devices (e.g., servers, mainframes, storage devices, personal computers (PCs) or the like) capable of executing computer-readable instructions. The apparatus 600 includes a computing platform 602 that can execute instructions, such as algorithms, modules, routines, applications and the like. Computing platform 602 includes memory 604, which may comprise volatile and non-volatile memory, such as read-only and/or random-access memory (RAM and ROM), EPROM, EEPROM, flash cards, or any memory common to computer platforms).

Moreover, memory 604 may comprise cloud storage, such as provided by a cloud storage service and/or a cloud connection service.

Further, computing platform 602 also includes processor 606, which may be an application-specific integrated circuit (“ASIC”), or other chipset, logic circuit, or other data processing device. Processor 606 may execute an application programming interface (“API”) 608 that interfaces with any resident instructions, such as instructions 610 and sub-instructions associated therewith or the like stored in the memory 604 of the computing apparatus 600.

Processor 606 may include various processing subsystems (not shown in FIG. 5) embodied in hardware, firmware, software, and combinations thereof, that enable the functionality of computing apparatus 600 and the operability of the apparatus 600 on a distributed computing network. For example, processing subsystems allow for initiating and maintaining communications and exchanging data with other networked devices. For the disclosed aspects, processing subsystems of processor 606 may include any subsystem used in conjunction with instructions 610 and related sub-instructions, sub-routines, algorithms, sub-algorithms, modules, sub-modules thereof.

Computer platform 602 may additionally include a communications module (not shown in FIG. 5) embodied in hardware, firmware, software, and combinations thereof, that enables electronic communications between the computing apparatus 600 and other networks, such as real-time processing network 300 (shown in FIGS. 1-4) and devices. Thus, communication module may include the requisite hardware, firmware, software and/or combinations thereof for establishing and maintaining a network communication connection.

Further, the memory 604 of apparatus 600 stores instructions 610 that are executable by processor 606. The instructions 610 are configured to, as part of a resource event conducted by a real-time processing network, such as a real-time transaction conducted by a RTP network, provide one or more resource event messages 620 to an object recipient that includes or provides access to object identification and volume data 632, such as, in the context of a real-time transaction, invoice data. The object identification and volume data 632 is related to the one or more objects (i.e., items and/or services) provided to the object recipient as a result of the resource event 310/transaction.

In specific embodiments of the invention, the object identification and volume data 632 may be included with a resource event request message 630, such as a payment request message. In those embodiments of the invention, in which the real-time processing network 300 is a real-time payment network, messaging occurs in accordance with International Standard Organization (ISO) 20022. In such embodiments, the payment request message (i.e., ISO 20022 PAIN.013 or the like) includes upwards of 140 bytes for inclusion of data. In other specific embodiments of the invention, in which the resource event request message 630 is unable to include all of the object identification and volume data 632, the resource event request message 630 may include a network-accessible pointer/link 634 to a network depository that stores the object identification and volume data 632. In other related embodiments of the invention, the resource event request message 630 may include a portion of the object identification and volume data 632 a network-accessible pointer/link 634 may provide access to the remaining portion or all of the object identification and volume data 632.

In other related embodiments of the invention, one or more other resource event messages 640 may include or provide access to the object identification and volume data 632. For example, in those embodiments in which the real-time processing network 300 is a real-time payment network, the object identification and volume data 632 may be included in a remittance message (ISO20022 REMT.001 or the like), which is unbounded in message size. In one specific embodiment of the invention, a resource event request message 630, which does not include object identification and volume data is communicated to the object recipient and, in response to the object recipient initiates a request for information message (ISO 20022 CAMT.0026 or the like) requesting the object identification and volume data 632. In response another resource event message 640, such as a remittance message (ISO20022 REMT.001 or the like) is generated and communicated to the object recipient and includes the object identification and volume data 632 and, in some embodiments, includes a pointer/link 634 to network-accessible object identification and volume data 632.

In optional embodiments of the apparatus 600, the instructions 610 include object identification and volume data determination logic 670 that is configured to determine whether the object identification and volume data 632 should be included in (i) a resource event request message 630, (ii) another message 640 and/or (iii) made network accessible via a link/pointer to the data 634 placed in the request message 630 or another message 640. In specific embodiments of the invention the determination is based at least in part on the volume of data (e.g., size of the invoice or the like) and/or formatting constraints dictated by the object recipient's inventory management system.

In other optional embodiments of the apparatus 600, the instructions 610 include format logic 660 configured to format the object identification and volume data 632 in an object-recipient format 662. The object-recipient format 662 may be the format used by the object tracking management system 150 (shown in FIGS. 1-4) or the like.

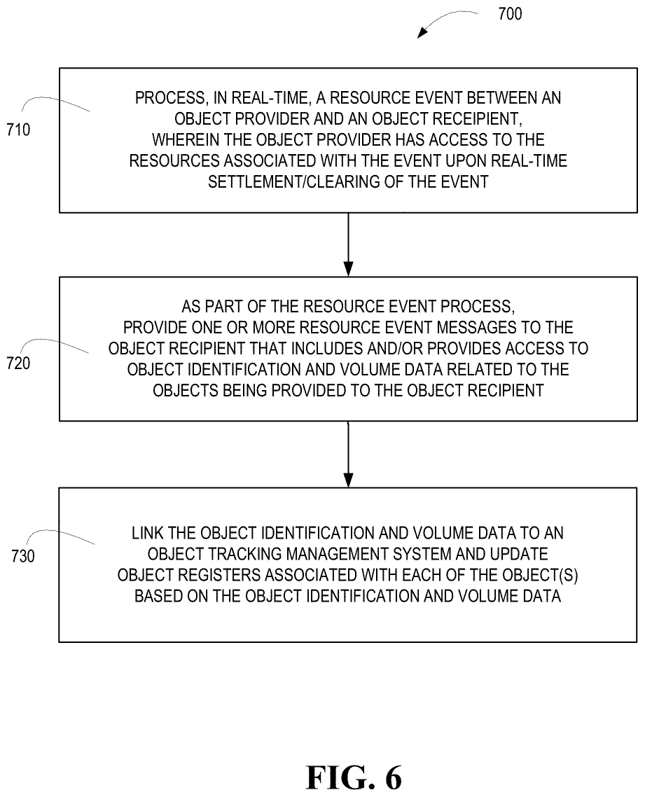

Referring to FIG. 6 a flow diagram is depicted of a method 700 for providing object identification and volume data in conjunction with a real-time resource event, in accordance with embodiments of the invention. At Event 710, a resource event between an object provider and an object recipient is processed in real-time. The object provider has access to the resources associated with the resource event upon real-time settlement/clearing of the resource event. In specific embodiments of the method, the resource event is a transaction/disbursement processed by a real-time payment network. In such embodiments of the invention, the item/service provider is the payee and the item/service recipient is the payor.

At Event 720, as part of the resource event, one or more resource event messages are provided to the object recipient that includes and/or provides access to object identification and volume data related to the objects being provided/transferred to the object recipient. In specific embodiments of the invention, in which the resource event is a transaction/disbursement processed by a real-time payment network, the messages include or provide access to invoice data (e.g., identification of items/services in the transaction and the associated quantity of the items/services and the like). In specific embodiments of the invention, the invoice data is included in a payment request message, while in other embodiments of the invention, a link/pointer is provided in the payment request message that, when activated, provides network-access to a repository storing the invoice data, In other embodiments of the method, the invoice data is included in a subsequent message sent to the object recipient/payor, such as a remittance message or the like.

At Event 730, the object identification and volume data is linked to an object tracking management system and object registers associated with each of the objects in the resource event are updated based on the object identification and volume data. In those embodiments of the method, in which the resource event is a transaction/disbursement processed by a real-time payment network, the invoice data is linked to an inventory management system and item/service lists associated with the items/services in the transaction are updated to reflect the current quantity of the items/services in the item/service recipient's inventory. In specific embodiments of the invention, the data is linked proximate to or in real or near-real time to the processing of the resource event (e.g., proximate to or real-time/near-real time to settling/clearing the transaction via the RTP network).

Thus, present embodiments of the invention, including systems, apparatus, methods and/or the like, provide for object identification and volume data in conjunction with the real-time processing of a resource event. The object identification and volume data is included in or accessible via one or more resource event messages communicated to the object recipient. In addition, the object identification and volume data is linked or otherwise provided in real-time to an object tracking management system associated with the object receipt, so that the system can immediately update the object registers associated with each of the objects.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing real-time object identification and tracking management, the system comprising:
a real-time processing computer network configured to process a resource event between an object provider and an object recipient in real-time and including:
a first computing platform having a first memory and at least one first processor in communication with the first memory, wherein the first memory stores first instructions that are executable by the at least one first processor and configured to:
as part of a resource event request process, provide one or more resource event messages to the object recipient that includes or provides access to object identification and volume data related to one or more objects being provided to the object recipient as a result of the resource event; and
a first object tracking management system associated with the object recipient and configured to manage acquisition and storage of objects and including:
a second computing platform having a second memory and at least one second processor in communication with the second memory, wherein the second memory stores second instructions that are executable by the at least one second processor and configured to:
receive, in real-time with processing of the resource event, the object identification and volume data related to the one or more objects, and
update an object register associated with each of the one or more objects to include the object identification and volume data related to each of the one or more objects.

2. The system of claim 1, wherein the first instructions configured to provide the one or more resource event messages are further configured to provide a resource event request message to the object recipient that includes the object identification and volume data related to the one or more objects being provided to the object recipient.

3. The system of claim 1, wherein the first instructions configured to provide the one or more resource event messages are further configured to provide a resource event request message to the object recipient that includes an activatable pointer to a data repository that stores the object identification and volume data related to the one or more objects being provided to the object recipient.

4. The system of claim 1, wherein the first instructions configured to provide the one or more resource event messages are further configured to logically determine to include in a resource event request message at least one selected from a group of (i) the object identification and volume data related to the one objects, and (ii) an activatable pointer to a data repository that stores the object identification and volume data related to the one or more objects being provided to the object recipient.

5. The system of claim 1, wherein the first instructions configured to provide the one or more resource event messages are further configured to, in response to providing a resource event request to the object recipient and receiving an object data request from the object recipient, provide a remittance message to the object recipient that includes the object identification and volume data related to the one or more objects being provided to the object recipient.

6. The system of claim 5, wherein the first instructions are further configured to provide the resource event request that includes notification of availability of the object identification and volume data related to the one or more objects being provided to the object recipient.

7. The system of claim 1, wherein the second instructions are configured to:
communicate data associated with the updated object registers associated with each of the one or more objects.

8. The system of claim 7, further comprising:
a second object tracking management system associated with the object provider and configured to manage allotment and storage of objects and including:
a third computing platform having a third memory and at least one third processor in communication with the third memory, wherein the third memory stores third instructions that are executable by the at least one third processor and configured to:
receive, from the first object tracking management system, the data associated with the updated object registers associated with each of the one or more objects, and
update, in real-time with the processing of the resource event, an object recipient-specific object register associated with each of the one or more objects to include the data associated with the updated object registers associated with each of the one or more objects.

9. The system of claim 1, further comprising a resource event reconciliation management system associated with the object recipient and including:
a third computing platform having a third memory and at least one third processor in communication with the third memory, wherein the third memory stores third instructions that are executable by the at least one third processor and configured to:
receive, in real-time with processing of the resource event, the object identification and volume data related to the one or more objects, and
reconcile a prior instruction made by the object recipient for receiving the one or more objects.

10. The system of claim 9, wherein the third instructions configured to reconcile the prior instructions are further configured to reconcile the prior instructions by confirming that (i) an identity of the one or more objects and (ii) a volume of each of the one or more objects in the resource event matches the prior instructions.

11. The system of claim 1, wherein the first instructions are further configured to format the object identification and volume data so as to be readable by the first object tracking management system.

12. An apparatus for providing object identification and volume data as part of a real-time resource event, the system comprising:
a computing platform having a memory and at least one processor in communication with the memory, wherein the memory stores instructions that are executable by the at least one processor and configured to:
process, in real-time, a resource event between an object provider and an object recipient; and
while processing the resource event, provide one or more resource event messages to the object recipient that includes or provides access to object identification and volume data related to one or more objects being provided to the object recipient.

13. The apparatus of claim 12, wherein the instructions configured to provide the one or more resource event messages are further configured to provide a resource event request message to the object recipient that includes the data related to the one or more objects being provided to the object recipient.

14. The apparatus of claim 12, wherein the instructions configured to provide the one or more resource event messages are further configured to provide a resource event request message to the object recipient that includes an activatable pointer to a data repository that stores the data related to the one or more objects being provided to the object recipient.

15. The apparatus of claim 12, wherein the instructions configured to provide the one or more resource event messages are further configured to logically determine to include, in a resource event request message, at least one selected from a group of (i) the data related to the one objects, and (ii) a an activatable pointer to a data repository that stores the data related to the one or more objects being provided to the object recipient.

16. The apparatus of claim 12, wherein the instructions configured to provide the one or more messages are further configured to, in response to providing a resource event request to the object recipient and receiving an object data request from the object recipient, provide a remittance message to the object recipient that includes the data related to the one or more objects being provided to the object recipient.

17. A computer program product comprising:
a non-transitory computer-readable medium comprising:
a first set of codes for causing a computer to process, in real-time, a resource event between an object provider and an object recipient; and
a second set of codes for causing a computer, while processing the resource event, provide one or more resource event messages to the object recipient that includes or provides access to object identification and volume data related to one or more objects being provided to the object recipient.

18. The computer program product of claim 17, wherein the second set of codes is further configured to provide a resource event request message to the object recipient that includes at least one (i) the data related to the one or more objects being provided to the object recipient and (ii) an activatable pointer to a data repository that stores the data related to the one or more objects being provided to the object recipient.

19. The computer program product of claim 17, wherein the second set of codes is further configured to, in response to providing a resource event request to the object recipient and receiving an object data request from the object recipient, provide a remittance message to the object recipient that includes the data related to the one or more objects being provided to the object recipient.

20. The computer program product of claim 17, further comprising a third set of codes for causing a computer to format the object identification and volume data so as to be readable by the first object tracking management system.
